(19) United States
(12) Patent Application Publication
(10) Pub. No.: US 2020/0183678 A1
(43) Pub. Date: Jun. 11, 2020

(54) SOFTWARE CLASSIFICATION

(71) Applicants: Xiang TAN, Shanghai (CN); Jin WANG, Shanghai (CN); Qiuxia SONG, Shanghai (CN); Jian-Feng HAN, Shanghai (CN); Yi XU, Shanghai (CN); HEWLETT PACKARD ENTERPRISE DEVELOPMENT LP, Houston, TX (US)

(72) Inventors: XIANG TAN, SHANGHAI (CN); JIN WANG, SHANGHAI (CN); QlUXIA SONG, SHANGHAI (CN); JIAN-FENG HAN, SHANGHAI (CN); YI XU, SHANGHAI (CN)

(21) Appl. No.: 16/341,120

(22) PCT Filed: Dec. 8, 2016
(86) PCT No.: PCT/CN2016/108992

§ 371 Date: Apr. 11, 2019

(51) Int. Cl. G06F 8/71

(52) U.S. Cl. CPC G06F 8/71

(57) ABSTRACT

Examples described relate to classifying software. In an example, a determination may be made whether a software installation directory includes a file to run software. In response to a determination that the software installation directory includes a file to run the software, information may be extracted from text data associated with the software installation directory using named entity recognition technique. The files in the software installation directory may be classified as one of a primary file, a secondary file, or a tertiary file based on respective relevance scores of the files, wherein the respective relevance scores may represent respective relevance of the files against the extracted information.

### BACKGROUND

The Information technology (IT) infrastructure of organizations may vary in scale and scope based on the organization's size and respective requirements. For example, the number of software applications deployed in an organization may vary from a few basic software applications (for example, email) to a large number of applications.

### BRIEF DESCRIPTION OF THE DRAWINGS

For a better understanding of the solution, examples will now be described, purely by way of example, with reference to the accompanying drawings, in which:

FIG. 1 is a block diagram of an example computing environment for classifying software;

FIG. 2 illustrates example text data associated with a software installation directory;

FIG. 3 is a block diagram of an example computing system for classifying software;

FIG. 4 is a flowchart of an example method of classifying software; and

FIG. 5 is a block diagram of an example system including instructions in a machine-readable storage medium for classifying software.

### DETAILED DESCRIPTION

The IT environment of an enterprise may comprise of a handful of software applications to hundreds of applications. In some cases, complex license models combined with easily installable software may drive the management of software assets to become uncontrollable, causing failed audits and unexpected spending.

Accurate and fast software recognition may provide a number of benefits to an enterprise. For example, it may help prevent software overspend, avoid new purchases, respond quickly to external and internal software audits, and reduce manual effort involved with Software Asset Management (SAM) activities. However, identifying software applications installed in an enterprise environment and the ability to know what and where software is being used may pose technical challenges.

To address these technical challenges, the present disclosure describes various examples for classifying software (machine-executable instructions). In an example, a determination may be made whether a software installation directory includes a file to run software. In response to a determination that the software installation directory includes a file to run the software, information may be extracted from text data associated with the software installation directory using named entity recognition technique. Further, respective relevance scores of the files in the software installation directory may be determined, wherein the respective relevance scores may represent respective relevance of the files against the extracted information. The files may be classified as one of a primary file, a secondary file, or a tertiary file based on their respective relevance scores.

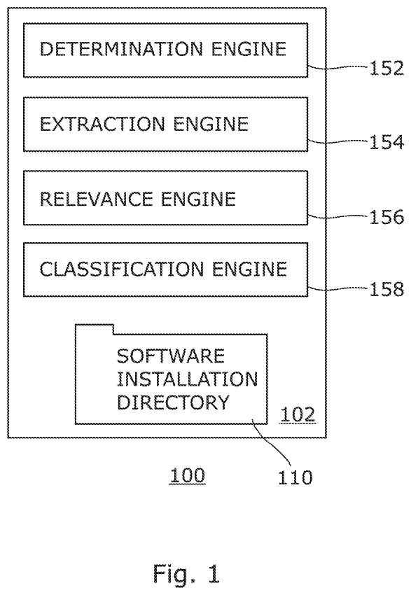

FIG. 1 is a block diagram of an example computing environment 100 for classifying software. In an example, computing environment 100 may include a computing device 102. Although one computing device is shown in FIG. 1, other examples of this disclosure may include more than one computing device, which may be communicatively coupled, for example, via a computer network. The computer network may be a wireless or wired network. The computer network may include, for example, a Local Area Network (LAN), a Wireless Local Area Network (WAN), a Metropolitan Area Network (MAN), a Storage Area Network (SAN), a Campus Area Network (CAN), or the like. Further, the computer network may be a public network (for example, the Internet) or a private network (for example, an intranet).

Computing device 102 may represent any type of system capable of reading machine-executable instructions. Examples of the computing device 102 may include a server, a desktop computer, a notebook computer, a tablet computer, a thin client, a mobile device, a personal digital assistant (PDA), and the like.

In an example, computing 102 device may include a determination engine 152, an extraction engine 154, a relevance engine 156, and a classification engine 158.

Engines 152, 154, 156, and 158 may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of the computing device 102. In some examples, the at least one machine-readable storage medium may store instructions that, when executed by the at least one processing resource, at least partially implement some or all engines of the computing device. In such examples, the computing device 102 may include the at least one machine-readable storage medium storing the instructions and the at least one processing resource to execute the instructions.

In an example, determination engine 152 may determine whether a software installation directory on computing device 102 includes a file(s) to run software. Such files may include a file without which the software may not run. For example, an executable file (e.g., .exe file).

As used herein, a software installation directory may refer to a directory that stores the program files of software (or computer application). In some examples, the software installation directory may be referred to as application installation directory, program installation directory, or program files folder.

In an example, software may be installed across multiple directories on computing device. However, a file(s) to run the software (e.g., an executable file) may be present in one directory. In an example, a determination engine 152 may identify a software installation directory that includes such a file(s).

Determination engine 152 may use a machine learning model to determine whether a software installation directory includes a file(s) to run the software. In an example, the machine learning model may be based on gradient boosted decision trees technique. The gradient boosted decision trees technique provides a method for generating models for regression and classification tasks. Gradient boosted decision trees technique may produce a prediction model in the form of an ensemble of weak prediction models. Gradient boosting may be used to build the model in a stage-wise fashion, and it generalizes them by allowing optimization of an arbitrary differentiable loss function.

In an example, the input data for the machine learning model may include a scan file(s). A scan file may include a document that includes the file structure of all the directories on a computing device (for example, 102) along with information related to the respective directories and the respective files present in those directories. Each directory together with its first level sub-files may be treated as a single training record for the machine learning model.

In an example, before scan files are used as input data for the machine learning model, irrelevant, redundant, or highly correlated features may be eliminated from the original dataset to create a minimal set of features. In an example, the features shown in Table 1 below may be used in the machine learning model.

TABLE 1
dep-depth of directory
os-operating system
wc-number of words in a directory path
tf-number of files under a directory, not including a sub directory
fp-number of files belonging to an installed package
cp-number of capital letters in a directory path
cpratio-number of capital letters divided by number of words in a
directory path name (cp/wc)
nd-a count of digital numbers in a directory path
sl-number of “-” or “_” in a directory path (e.g., “/Program
Files/Markitserv/SW_12_2_265269”)
np-number of “.” in a directory path (e.g., “/Program Files (x86)/PSI
Navigator 1.0”)
bin-[0, 1] whether a directory path ends with “bin” (e.g., “/Program
Files/IBM/HTTPServer/bin”), wherein 1 and 0 may represent a true and
false condition, respectively
lib-[0, 1] whether a directory path ends with “/lib” (e.g., “/Program
Files/IBM/HTTPServer/lib”), wherein 1 and 0 may represent a true and
false condition, respectively
eloc-[0, 1] whether a directory path ends with locale (e.g., “/Program
Files/IBM/HTTPServer/zh-CHS”), wherein 1 and 0 may represent a true
and false condition, respectively
nexe-number of executable files under a directory
exeratio-number of executable files divided by total number of files
nexe/tf)
lsim-0.0~1.0, the highest similarity score between a file name (without
file extension) and the last path word. For example, if a directory whose
last path word is “SeaCOM” includes three files: “SeaX.exe, SeaC.dll,
SeaCo.exe”. The Jaro-Winkler distances between each file name “SeaX,
SeaC, SeaCo” and the last path word “SeaCOM” may be computed, and
the highest similarity value may be returned; wherein 0.0~1.0 may
represent a real number between 0 and 1, for example, 0.783

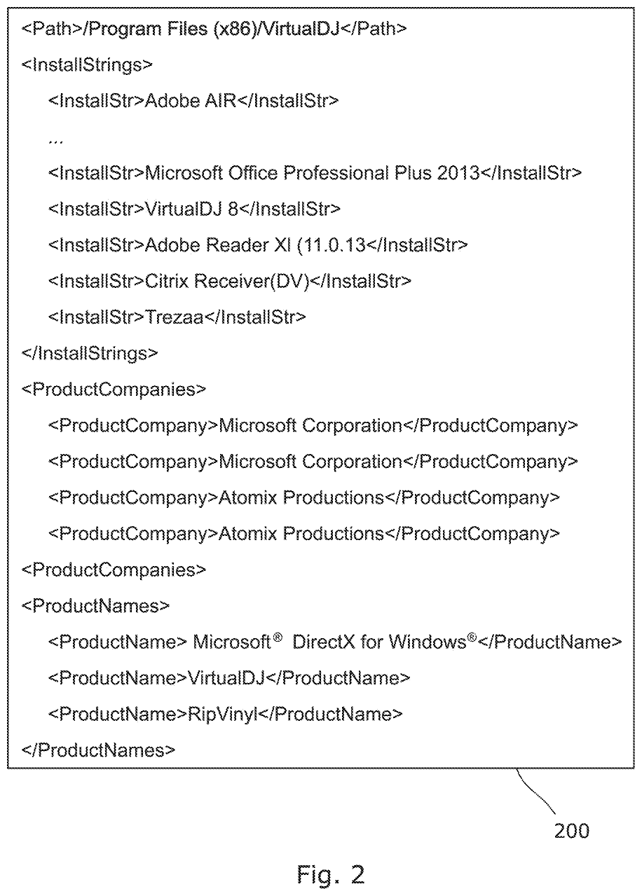

In response to a determination by determination engine 152 that the software installation directory may include a file(s) to run the software, extraction engine 154 may extract information from text data associated with the software installation directory. FIG. 2 shows example text data 200 associated with a software installation directory, In an example, extraction engine 154 may use a named entity recognition technique for extracting information from text data. In an example, the information extracted by extraction engine may include named entities. Named entity recognition is a technique of identifying such named entities. As used herein, a named entity may refer to a real-world object, such as persons, locations, organizations, products, numerical values, dates, time, etc., that can be denoted with a proper name. Examples of named entities may include Abraham Lincoln, Chicago, Hewlett Packard Enterprise, etc.

In an example, the information (or named entities) extracted by extraction engine may include a publisher of software in the software installation directory, a name of the software, and a version of the software. Referring to FIG. 2, extraction engine may extract the following named entities from the example text data: “Atomix” and “Microsoft” as publishers of software applications, “VirtualDJ” and “Rip Vinyl” as names of software, and “8” as the version of software VirtualDJ from install strings in the text data.

In an example, extraction engine 154 may first extract the publisher of software from the text data associated with the software installation directory. In an example, DBpedia ontology may be used to identify the publisher of software. DBpedia ontology refers to a shallow, cross-domain ontology that has been manually created on the most commonly used infoboxes in Wikipedia. DBpedia may allow users to semantically query relationships and properties of Wikipedia resources, including links to other related dataset. DBpedia may extract factual information from Wikipedia pages, and allow users to find answers to questions where the information is spread across many different Wikipedia articles. Data in DBpedia may be accessed using an SQL-like query language. Once the publisher of software has been identified, extraction engine 154 may determine the name of the software, and the version of the software from the text data.

After the information from the text data associated with the software installation directory is extracted, classification engine 152 may classify files in the software installation directory as one of a main file, an associated file, or a third party file based on respective relevance scores of the files. As used herein, a “main file” may refer to a file without which software may not run; an “associated file” may refer to an ancillary file written by the publisher of the software without which the software may run; and a “third party file” may refer to a file written by a publisher other than the publisher of the software.

In some examples, a different nomenclature may be used for referring to a main file, an associated file, and a third party file. For example, a main file, an associated file, and a third party file may be referred to as a “primary file”, a “secondary file”, and a “tertiary file” respectively.

The relevance score of a file may represent the relevance of the file to software installed in the software installation directory. Relevance engine 156 may determine the relevance score of a file. In an example, relevance engine 156 may convert each FileEntry of the files in the software installation directory into a text “query”, and the information (or named entities) extracted from the text data as “documents”. As used herein, a “FileEntry” may be an object that represents a file on a file system. In the context of example text data illustrated in FIG. 2, examples of text queries (“Text (q)”) based on the text data are given below in Table 2A. Examples of “documents” based on the example text document are given below in Table 2B.

TABLE 2A

| Document(d) | |
|---|---|
| D1(Directory | Program Files (x86) VirtualDJ |
| name) | |
| D2(Install String) | VirtualDJ 8 |
| D3(Publisher) | Atomix Productions Atomix |
| | Productions Microsoft Corporation |
| | Microsoft Corporation |
| D4(Application) | VirtualDJ RipVinyl |

TABLE 2B

| Name | Tex (q) |
|---|---|
| crashguard3.exe | crashguard3 exe |
| D3DCompiler_43.dll | D3DCompiler_43 dll Microsoft ® DirectX for Windows® Microsoft |
| | Corporation |
| D3DX9_43.dll | D3DX9_43 dll Microsoft ® DirectX for Windows® Microsoft |
| | Corporation |
| ripdvd.exe | ripdvd exe |
| ripvinyl.exe | ripvinyl exe RipVinyl Atomix Productions |
| virtualdj8.exe | virtualdj8 exe VirtualDJ Atomix Productions |
| virtualdj_pro.exe | virtualdj_pro exe |

Relevance engine 156 may determine the relevance between a query and the documents for each FileEntry. In an example, relevance engine may first remove stop words from “queries” and “documents”. As used herein, stop words may refer to words which may be filtered out before or after processing of natural language data. Stop words may refer to the most common words in a language. Some examples of the stop words may include “the”, “is”, “at”, “which”, “on”, etc. Any group of words may be chosen as stop words for a given purpose. In the context of present disclosure, relevance engine 156 may remove stop words such as “program files”, “bin”, “lib”, and other words that are likely to occur frequently in queries and documents. The aforementioned are just some examples of the stop words that may be removed by relevance engine 156.

Relevance engine 156 may determine the name of software and the publisher of the software installed in the software installation directory from all possible candidates based on document frequency. Relevance engine 156 may use a ranking function for this purpose. In an example, the ranking function may be based on Okapi BM25. BM25 is a ranking function which may be used to rank matching documents according to their relevance to a given search query. An example ranking function that may be used by relevance engine 156 is given below.

$$f ( q , d ) = ( \sum \text{?} c ( w , q ) \frac{( k + 1 ) c ( w , d )}{c ( w , d ) + k ( 1 - b + b \frac{\vert d \vert}{avdl} )} log \frac{M + 1}{df ( w )} ) + similarity ( q , d )$$

$$\text{?} \text{indicates text missing or illegible when filed}$$

where:
c(w,q) may be the count of the word “w” in query “q”
c(w,d) may be the count of the word “w” in document “d”
M may be the total number of documents
df(w) may be the number of documents containing the word “w”
   |d| may be the length of the document
advl may be the average document length
k and b may be the parameters used in BM25, k≥0 and b∈[0,1]
similarity(q,d) may be the similarity between a file name and a target document. In an example, the similarity function may be a Jaro-Winkler distance between two strings. A Jaro-Winkler distance represents a measure of similarity between two strings.

In an example, after each file in the software installation directory has been ranked, a final score function for each file may be determined by relevance engine 156 based on the equation given below.

score(Q)=k₁ƒ(q,d₁)+k₂ƒ(q,d₂)+k₃ max(ƒ(q,d₃),ƒ(q,d₄)))+k₄I(q)

Where k₁ . . . k₄ are the weights that may need to be tuned, and I_{(q)} may be an indicator function:

$$I ( q ) = \{ \begin{matrix}1 if {}_{ }^{“}{exe}{}_{ }^{”} ∈ q \\ 0 if {}_{ }^{“}{exe}{}_{ }^{”} ∉ q\end{matrix}$$

In an example, the highest ranking file which is above a threshold α may be classified as the main file by classification engine 158. The files whose score are below a threshold β may be classified as third party files by classification engine 158. The remaining files may be classified as associated files by classification engine 158.

In the context of example text data illustrated in FIG. 2, an example file classification is illustrated in Table 3 below.

TABLE 3

| Name | Classification |
|---|---|
| crashguard3.exe | Associated |
| D3DCompiler_43.dll | Third Party |
| D3DX9_43.dll | Third Party |
| ripdvd.exe | Associated |
| ripvinyl.exe | Associated |
| virtualdj8.exe | Main |
| virtualdj_pro.exe | Associated |

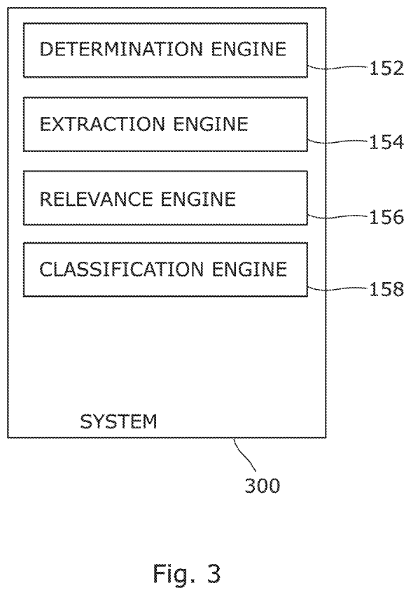

FIG. 3 is a block diagram of an example computing system 300 for classifying software. In an example, computing system 300 may be analogous to the computing device 102 of FIG. 1, in which like reference numerals correspond to the same or similar, though perhaps not identical, components. For the sake of brevity, components or reference numerals of FIG. 3 having a same or similarly described function in FIG. 1 are not being described in connection with FIG. 3. Said components or reference numerals may be considered alike.

In an example, system 300 may represent any type of computing device capable of reading machine-executable instructions. Examples of computing device may include, without limitation, a server, a desktop computer, a notebook computer, a tablet computer, a thin client, a mobile device, a personal digital assistant (PDA), and the like.

In an example, system 300 may include a determination engine 152, an extraction engine 154, a relevance engine 156, and a classification engine 158.

In an example, determination engine 152 may determine whether a software installation directory includes a file to run software. In response to a determination that the software installation directory includes the file to run the software, extraction engine 154 may extract information from text data associated with the software installation directory using named entity recognition technique. In an example, the information may include a publisher of software in the software installation directory, a name of the software, and a version of the software. Relevance engine 156 may determine respective relevance scores of the files in the software installation directory. The respective relevance scores of the files may represent respective relevance of the files against the extracted information. Classification engine 158 may classify the files in the software installation directory as one of a main file, an associated file, or a third party file based on the respective relevance scores of the files. Once the files are classified, classification engine 158 may display the classified files on a display device (for example, a computer monitor). In an example, the display may in the form of a report.

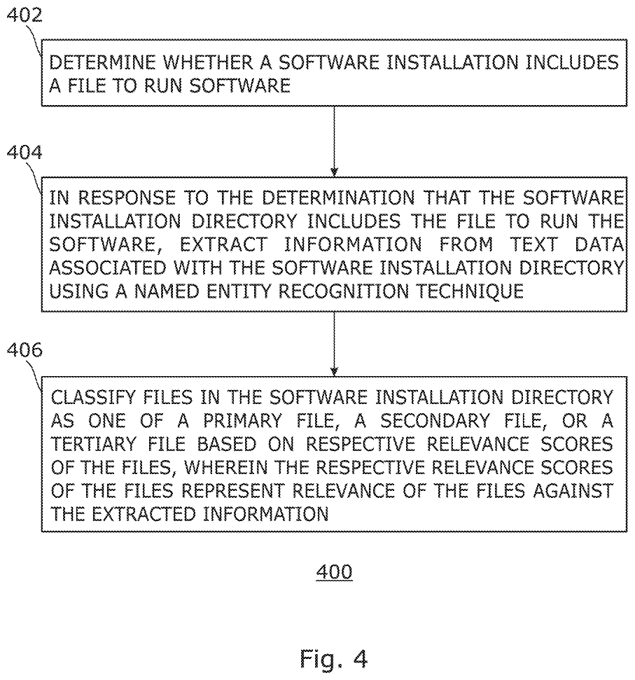

FIG. 4 is a flowchart of an example method 400 of classifying software. The method 400, which is described below, may be executed on a computing device such as computing device 102 of FIG. 1 or system 300 of FIG. 3. However, other computing devices may be used as well. At block 402, a determination may be made whether a software installation directory includes a file to run software. At block 404, in response to a determination that the software installation directory includes a file to run the software, information may be extracted from text data associated with the software installation directory using named entity recognition technique. At block 306, files in the software installation directory may be classified as one of a primary file, a secondary file, or a tertiary file based on respective relevance scores of the files. The respective relevance scores may represent respective relevance of the files against the extracted information.

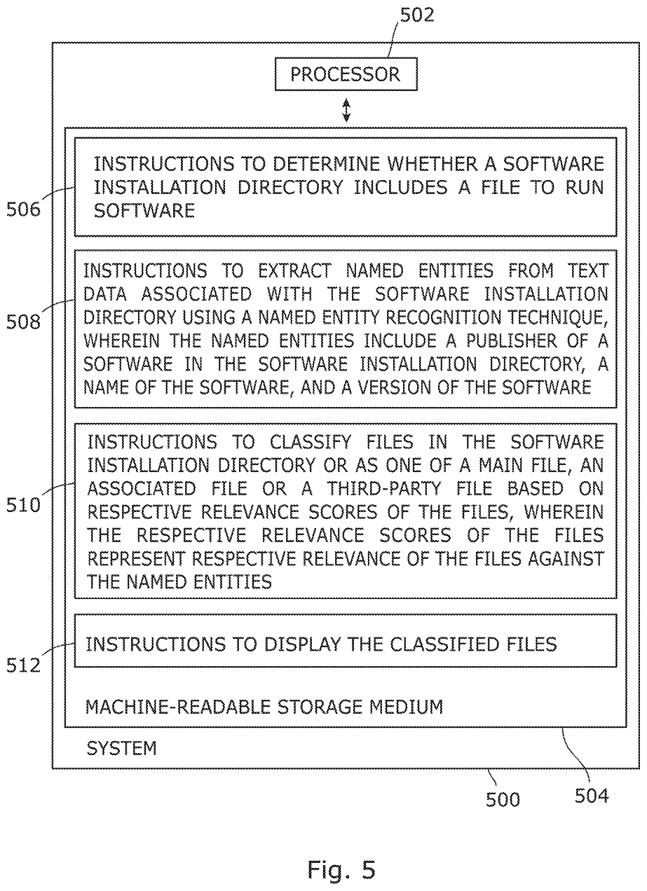

FIG. 5 is a block diagram of an example system 500 including instructions in a machine-readable storage medium for classifying software. System 500 includes a processor 502 and a machine-readable storage medium 504 communicatively coupled through a system bus. In some examples, system 500 may be analogous to computing device 102 of FIG. 1 or system 200 of FIG. 2. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 504 may store instructions 506, 508, 510, and 512. In an example, instructions 506 may be executed by processor 502 to determine whether a software installation directory includes a file to run software. Instructions 508 may be executed by processor 502 to extract named entities from text data associated with the software installation directory using named entity recognition technique, in response to the determination that the software installation directory includes the file to run the software. In an example, the named entities may include a publisher of software in the software installation directory, a name of the software, and a version of the software. Instructions 510 may be executed by processor 502 to classify files in the software installation directory as one of a main file, an associated file and a third-party file based on respective relevance scores of the files. The respective relevance scores of the files may represent respective relevance of the files against the named entities. Instructions 512 may be executed by processor 502 to display the classified files.

For the purpose of simplicity of explanation, the example method of FIG. 4 is shown as executing serially, however it is to be understood and appreciated that the present and other examples are not limited by the illustrated order. The example systems of FIGS. 1, 3, and 5, and method of FIG. 4 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution.

1. A method comprising:
by a processor
determining whether a software installation directory includes a file to run software;
in response to the determination that the software installation directory includes the file to run the software, extracting information from text data associated with the software installation directory using a named entity recognition technique; and
classifying files in the software installation directory as one of a primary file, a secondary file, or a tertiary file based on respective relevance scores of the files, wherein the respective relevance scores of the files represent respective relevance of the files against the extracted information.

2. The method of claim 1, wherein the information includes a publisher of software in the software installation directory, a name of the software, and a version of the software,

3. The method of claim 1, further comprising determining the respective relevance scores of the files.

4. The method of claim 3, wherein determining the respective relevance scores of the files includes:
converting respective file entries of the files into respective text queries, wherein the respective file entries represent the files in a file system; and
querying the respective text queries against the extracted information.

5. The method of claim 3, further comprising removing stop words from the extracted information prior to determining the respective relevance scores of the files.

6. A system comprising:
a determination engine to determine whether a software installation directory includes a file to run software;
an extraction engine to, in response to the determination that the software installation directory includes the file to run the software, extract information from text data associated with the software installation directory using a named entity recognition technique, wherein the information includes a publisher of software in the software installation directory, a name of the software, and a version of the software; and
a relevance engine to determine respective relevance scores of files in the software installation directory, wherein the respective relevance scores of the files represent respective relevance of the files against the extracted information; and
a classification engine to classify the files in the software installation directory as one of a main file, an associated file, or a third party file based on the respective relevance scores of the files.

7. The system of claim 6, wherein the extraction engine to identify the publisher of the software using DBpedia ontology.

8. The system of claim 6, wherein the main file includes the file to run the software.

9. The system of claim 6, wherein the associated file includes an ancillary file from the publisher of the software.

10. The system of claim 6, wherein the third party file includes a file from another publisher other than the publisher of the software.

11. A non-transitory machine-readable storage medium comprising instructions, the instructions executable by a processor to:
determine whether a software installation directory includes a file to run software;
in response to the determination that the software installation directory includes the file to run the software, extract named entities from text data associated with the software installation directory using named entity recognition technique, wherein the named entities include a publisher of software in the software installation directory, a name of the software, and a version of the software;
classify files in the software installation directory as one of a main file, an associated file, or a third-party file based on respective relevance scores of the files, wherein the respective relevance scores of the files represent respective relevance of the files against the named entities; and
display the classified files.

12. The storage medium of claim 11, wherein the instructions to determine include instructions to use a gradient boosted decision trees model to determine whether the software installation directory includes a file to run the software.

13. The storage medium of claim 11, wherein the main file includes a file with a highest relevance score above a pre-defined first threshold.

14. The storage medium of claim 11, wherein the third party file includes a file with a relevance score less than a pre-defined second threshold.

15. The storage medium of claim 11, wherein the associated file includes a file with a relevance score less than the pre-defined first threshold and more than the pre-defined second threshold.
